(19) United States
(12) Patent Application Publication
(10) Pub. No.: US 2005/0119009 A1
(43) Pub. Date: Jun. 2, 2005

(54) Method and system for recording physical information related to a moving vehicle during wireless communications

(75) Inventors: Frederic Bauchot, Saint Jeannet (FR); Gerard Marmigere, Drap (FR); Pierre Secondo, Tourrettes sur Loup (FR)

Correspondence Address: HOFFMAN, WARNICK & D'ALESSANDRO LLC, THREE E-COMM SQUARE, ALBANY, NY, 12207, US

(73) Assignee: International Business Machines Corporation, Armonk, NY (US)

(21) Appl. No.: 10/980,356

(22) Filed: Nov. 3, 2004

(30) Foreign Application Priority Data
Nov. 27, 2003 (EP) 03368102.4

(51) Int. Cl. H04B 1/00

(52) U.S. Cl. 455/456.1

(57) ABSTRACT

The present invention is directed to a method and a system for detecting a wireless telephone communication in a vehicle, and once detected, starts recording the value of relevant physical parameters of the vehicle. For instance, these parameters are the current time at which the telephone communication is received or placed, and optionally, the geographical position of the vehicle. In a particular embodiment, the values of the various parameters are recorded at regular time intervals until the communication terminates.

### TECHNICAL FIELD

The present invention relates to wireless communications, and more particularly to a system and method for recording physical information related to a moving vehicle during a wireless communication.

### BACKGROUND ART

Wireless communication is very common for private and business uses, and many businesses depend on this technology. In this context, a person driving a car often receives a call on his/her mobile phone or needs to call someone from his/her mobile phone. However, it is very dangerous (and even forbidden in some countries) to call or to answer phone calls while driving a car and it is recommended for drivers to switch off their mobile phones. Countries have established laws specifying the way and conditions mobile phones can or cannot be used in vehicles. However, in case of an accident, it is extremely difficult or even impossible for the police or an insurance company to legally determine whether or not a mobile phone was used in an involved vehicle at the time the accident occurred. It may also be very difficult for the driver to legally prove whether or not he/she was using his/her mobile phone at the time of the accident.

To solve this problem, it would be desirable to record in an accurate and auditable way, relevant physical information related to the vehicle such as speed, time and geographical position, when the driver of a vehicle gives or receives a call with his/her wireless phone.

The problem is to record the values of one or more physical parameters related to a moving vehicle (such as speed, time or geographical position), each time a person within the vehicle places or receives a call using a wireless phone.

The system must be able to certify the correctness and integrity of these values at the time a wireless communication took place. The system must be reliable and trusted in any circumstances.

Furthermore, the system must be universal. In other words, the system must not depend on the telephone network, the telephone operator or the country in which the system is operating.

To limit the costs, the system must be easy to implement without impacting the architecture and design of existing communication apparatus.

The aforementioned problems of recording one or more vehicle parameters have already been addressed in the literature and various implementations exist. For instance, trucks are equipped with various recording systems. However, data recorded by these systems cannot be correlated with the telephone calls received in the vehicle or sent from the vehicle. Furthermore, since these systems are installed in the trucks, it is impossible to guarantee a full inviolability of data. Generally, only the speed is recorded with the time.

In conclusion, none of the aforementioned prior art techniques addresses the problem of correlating one or several physical parameters related to a moving vehicle with the occurrence of a wireless communication with a mobile phone.

### SUMMARY OF THE INVENTION

An object of the present invention is to record information related to a moving vehicle when an incoming or outgoing mobile telephone communication from the moving vehicle is detected.

A further object of the present invention is to record the vehicle speed, the current time, and optionally the geographical position of the vehicle when a communication is detected and during this communication,.

Another object of the present invention is to provide a simple and low cost solution for recording this information which does not depend on the wireless network and wireless apparatus.

The present invention is directed to a method and system for detecting a wireless telephone communication in a vehicle, and once detected, for recording the value of relevant physical parameters of the vehicle. For instance, these parameters may include the current time at which the telephone communication is received or placed, and optionally, the position of the vehicle. In a particular embodiment, the values of the various parameters are recorded at regular time intervals until the communication terminates.

More particularly, the present invention relates to a method and system for recording during a wireless communication in a vehicle, information relative to the vehicle. The method comprises the steps of: detecting a wireless communication with a mobile communication system in the vehicle; and, when a wireless communication with the mobile communication system in the vehicle is detected: retrieving information related to the vehicle; and recording the information.

The foregoing, together with other objects, features, and advantages of this invention can be better appreciated with reference to the following specification, claims and drawings.

### BRIEF DESCRIPTION OF THE DRAWINGS

The novel and inventive features believed characteristics of the invention are set forth in the appended claims. The invention itself, however, as well as a preferred mode of use, further objects and advantages thereof, will best be understood by reference to the following detailed description of an illustrative detailed embodiment when read in conjunction with the accompanying drawings, wherein:

FIG. 1 is a schematic view of the different components involved in the present invention.

FIG. 2 is a flow chart illustrating the method of recording the values taken by the various physical parameters of the vehicle according to the present invention.

FIG. 3 is a schematic view of the different components involved in the present invention, when the mobile communication system comprises a free hand system.

### DETAILED DESCRIPTION OF THE INVENTION

The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

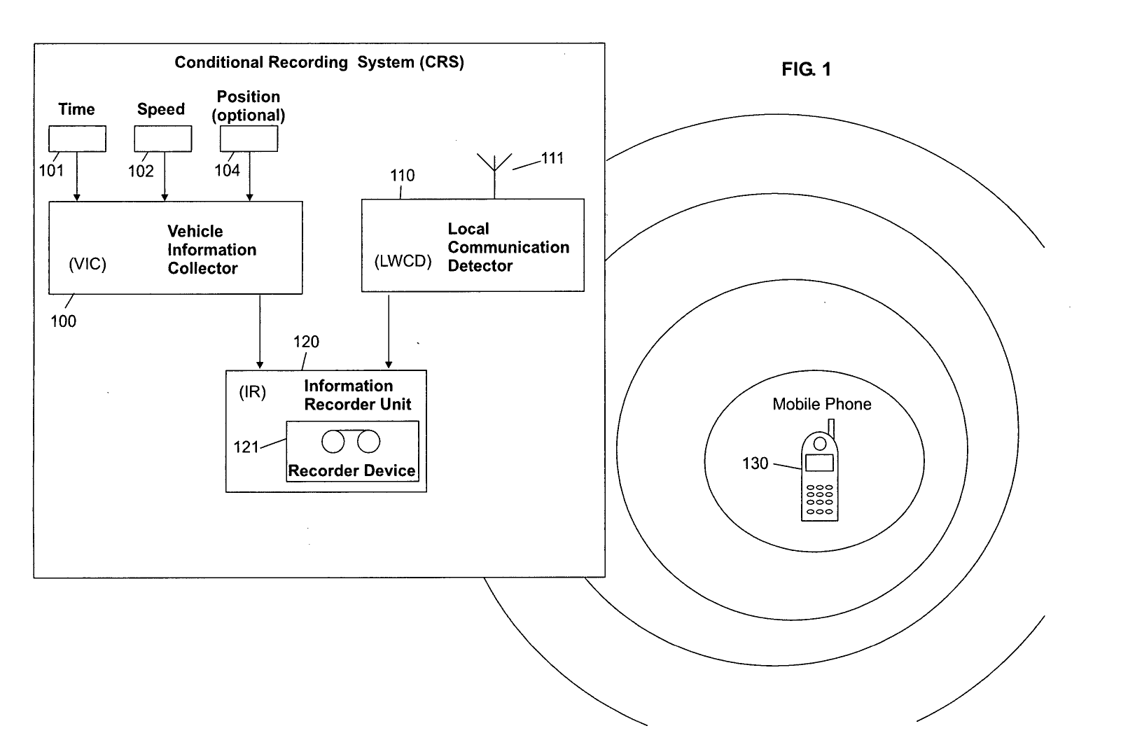

FIG. 1 is a schematic view of the different components involved in the preferred embodiment of the present invention.

The conditional recorder system (CRS) comprises an information recorder unit (IR) 120 connected to both a local wireless telephone communication detector unit (LWCD) 110, and a vehicle information collector unit (VIC) 100.

The vehicle information collector unit (VIC) 100 is itself, connected to different sources of information available within the vehicle including a clock 101, giving the current time, a speedometer 102, giving the current speed of the vehicle, and optionally a GPS (Global Positioning System) device 104, giving the current geographical position of the vehicle (x, y).

Cyclically (for instance, with a predefined frequency that can be adjusted) or on the occurrence of a particular event, the vehicle information collector unit (VIC) 100 builds a message where data provided by these three information sources is encoded. The message is then sent to the information recorder unit (IR) 120.

The local wireless telephone communication detector unit (LWCD) 110 comprises a radio receiver with an antenna 111, tuned to detect the energy emitted by the mobile communication system 130 in the UHF (Ultra High Frequencies) band when a communication is established. It is possible for the LWCD to detect communications because in “standby,” a cellular telephone emits a signal with very low energy in the range of few milli-watts, while during a communication, the emitted signal has an energy range comprised between a fraction of a watt up to two watts (for GSM telephones). This means that between the standby state and the communication state, the emitted energy varies according to a ratio of several hundreds to several thousands. When a communication is detected, the local wireless communication detector (LWCD) 110 sends to the information recorder (IR) unit 120, a signal “communication ON” by applying a predefined voltage on the line connecting the LWCD unit 110 to the information recorder unit (IR) 120. The “communication ON” signal is maintained as long as the wireless communication is detected. When the communication is terminated, a “communication OFF” signal is generated. In a preferred embodiment the “communication OFF” signal corresponds to a null voltage indicating an absence of communication.

The information recorder (IR) unit 120 includes a recorder device 121, similar to the recording systems (“spying black boxes” systems) currently used for trucks. The messages received from the vehicle information collector unit (VIC) 100 are recorded when the “communication ON” signal is received from the local wireless telephone communication detector unit (LWCD) unit 110, and/or as long as the “communication ON” signal is received from the local wireless telephone communication detector unit (LWCD) unit 110, preferably at regular time intervals, and/or on the occurrence of a particular event, for instance when the vehicle's speed exceeds a particular speed limit.

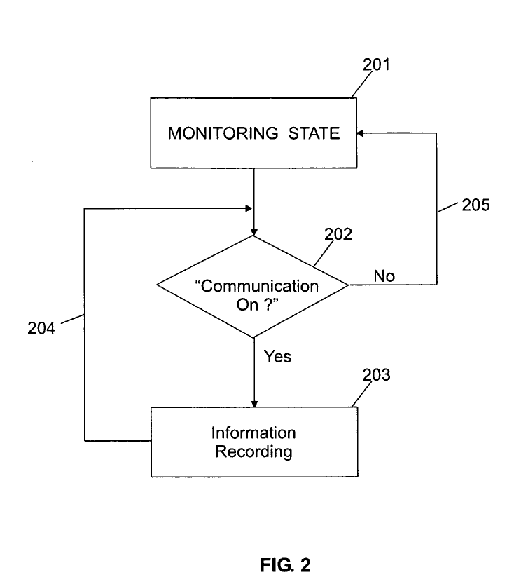

The method for recording physical information when wireless communications take place from a moving vehicle is summarized in flowchart 200 shown in FIG. 2. This method used in the Information Recording (IR) unit, comprises the following steps:

At step 201, the method is in its default state (monitoring state), and waits for the receipt of a “communication ON” signal sent from the local wireless telephone communication detector (LWCD) unit 110.

At step 202, a “communication ON” signal is received as the result of a wireless call detected by the LWCD unit 110.

At step 203, the information recording (IR) unit 120 starts to record the messages received from the vehicle information collector (VIC) unit 100.

Step 204 is a loop indicating that the information recording (IR) unit 120 continue to record the messages received cyclically from the vehicle information collector (VIC) unit as long as the “communication ON” signal is maintained in output of the LWCD 110 unit

At step 205, a “communication OFF” signal is sent by the LWCD 110 unit, as the result of the wireless call termination. The method returns to its default state 201 (monitoring state).

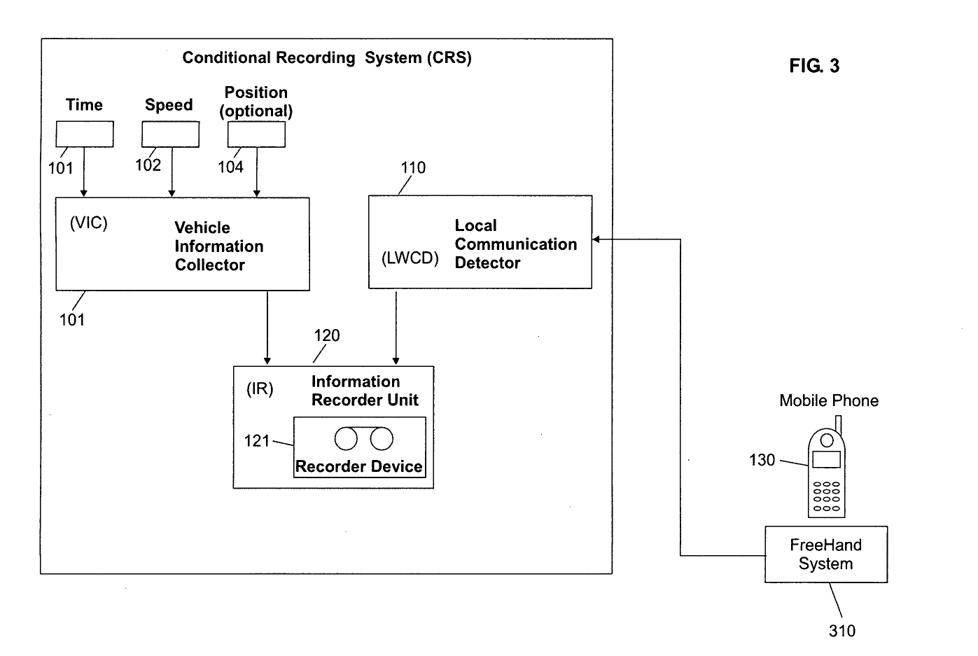

In an alternate embodiment as illustrated in FIG. 3 the mobile communication system comprises a free hand system 310 connected to a mobile phone 130, and the conditional recording system (CRS), is used in the vehicle jointly with this free hand telephone system 310. In this particular embodiment, the local wireless communication detector (LWCD) unit 110, is connected to the free hand telephone system 310. The LWCD monitors the “Audio OUT” signal in output of the free hand telephone system and generates a “communication ON” signal when a call is detected. The detection of a call is based on the variation of energy in output of the free hand telephone system.

1. A method for recording information relative to a vehicle during a wireless communication in the vehicle, comprising the steps of:
detecting a wireless communication in the vehicle, and if the wireless communication in the vehicle is detected:
retrieving information related to the vehicle; and
recording the information.

2. The method according to claim 1 wherein the steps of:
retrieving information related to the vehicle; and
recording the information;
are repeated as long as the wireless communication in the vehicle is detected.

3. The method according to claim 1 wherein the steps of:
retrieving information related to the vehicle; and
recording the information;
are repeated at an occurrence of a specific event as long as a wireless communication in the vehicle is detected.

4. The method according to claim 1 wherein the step of retrieving information related to the vehicle further comprises the step of:
retrieving a current time, and a vehicle speed measured at the current time.

5. The method according to claim 1 wherein the step of retrieving information related to the vehicle further comprises the step of:
retrieving a current position of the vehicle.

6. The method according to claim 1 wherein the step of detecting a wireless communication in the vehicle comprises further comprises the step of:
detecting a variation of energy emitted by a mobile communication system.

7. The method according to claim 1 wherein the wireless communication is provided by a mobile communication system comprising a free hand system and a mobile phone, and wherein the step of detecting a wireless communication in the vehicle comprises the further step of:
detecting a variation of energy in an output of the free hand system.

8. A system for recording information relative to a vehicle during a wireless communication in the vehicle, comprising:
a system for detecting a wireless communication in the vehicle;
a system for retrieving information related to the vehicle if the wireless communication in the vehicle is detected; and
a system for recording the information.

9. The system according to claim 8, wherein the retrieving system continues to retrieve information related to the vehicle and the recording system continues to record the information as long as the wireless communication in the vehicle is detected by the wireless communication detecting system.

10. The system according to claim 8 further comprising:
a system for detecting an occurrence of a specific event;
wherein the retrieving system retrieves information related to the vehicle at the occurrence of the specific event and the recording system records the information, as long as the wireless communication in the vehicle is detected by the wireless communication detecting system.

11. The system according to claim 8 wherein the system for retrieving information related to the vehicle further comprises:
a system for retrieving a current time, and a vehicle speed measured at the current time.

12. The system according to claim 8 wherein the system for retrieving information related to the vehicle further comprises:
a system for retrieving a current position of the vehicle.

13. The system according to claim 8 wherein the system for detecting a wireless communication in the vehicle further comprises:
a system for detecting a variation of energy emitted by a mobile communication system.

14. The system according to claim 8 wherein the wireless communication is provided by a mobile communication system comprising a free hand system and a mobile phone, and wherein the system for detecting a wireless communication in the vehicle further comprises:
a system for detecting a variation of energy in an output of the free hand system.
